(19) United States
(12) Patent Application Publication
(10) Pub. No.: US 2017/0030064 A1
(43) Pub. Date: Feb. 2, 2017

(54) Control of Toilet Bowl Odors by Fogging Nozzles

(71) Applicant: Thomas Clay Spencer, Virginia Beach, VA (US)

(72) Inventor: Pal Singh Gill, Chesapeake, VA (US)

(21) Appl. No.: 15/193,081

(22) Filed: Jun. 26, 2016

Related U.S. Application Data
(60) Provisional application No. 62/231,406, filed on Jul. 6, 2015.

(51) Int. Cl. E03D 9/00; B05B 15/00; B05B 9/01

(52) U.S. Cl. CPC E03D 9/005; B05B 9/01; B05B 15/008; E03D 9/08

(57) ABSTRACT

This invention relates to control of obnoxious odors from toilet bowl by fogging nozzles. This is accomplished by mounting fogging nozzles on an independent insert installed under the toilet seat on common mounting holes. Fogging nozzles are fed from the household water supply at 40-60 PSI. This is achieved by bifurcating water supply to the toilet tank or such water sources available in the bathroom. A control valve is used to control water supply and regulate water pressure to the fogging nozzles. Nozzles are directed to produce atomizing fog to fill the volume of the toilet bowl to capture and absorb air born odor molecules and drop into the pool of water in the bowl. Eventually the odor laden water is flushed at the end of cleaning cycle.

### FIELD OF INVENTION

The field of invention refers to control of odorous air from the toilet bowl during use. More particularly the objective is achieved by fogging the toilet bowl interior volume by specially designed nozzles for the purpose of capturing and submerging the odor molecules and finally dropping them in the pool of water at the drain for final flush.

### BACKGROUND OF THE INVENTION

The invention described here uses fogging nozzles to control obnoxious odors by diffusion and suppression processes. Molecules of odor are engulfed by fog particles and dropped into the captive pool of water at the drain. This phenomenon occurs by the principle of surface tension of water molecules forming water globules encapsulating the odor.

Recent trends in residential and commercial buildings architecture have located the bathrooms rather in the interior; cutting out the natural window or a ventilator to achieve proper venting. This trend most probably is the result of reducing HVAC losses. Most often a small exhaust fan is installed in the bathroom ceiling which, in no way, promptly removes heavier odor particulate from the enclosure during the use of the facility.

Various types of contraptions have been designed and installed to ventilate the obnoxious odor promptly as it is produced during toilet usage. These all have one thing in common that they require and use an electric fan to exhaust odor as it is being produced. The exhaust air is eventually piped out to outside of the building or forced through a specialty filter back into the building. An electric connection is a basic requirement of all these devices.

There is considerable interest in custom built toilets that incorporate enhanced features, also include electric power to perform their functions. The cost of such toilets is significantly higher and they are limited to upper class new construction. Such hardware cannot be easily retrofitted to existing toilets but used for replacement only resulting in new installation cost. These systems are mostly popular in Japan and other areas of the globe where cooking, dining and sleeping spaces are too close for comfort.

One of the proposed solutions is, described in U.S. Pat. No. 4,344,194,to force the odorous air through a filter. Odor is absorbed in the traditional carbon filter and recirculated. The filter system devised forms a compact air renewal system, which nonetheless requires an electric fan for operation. This system requires continuous replacement of used filters adding considerable cost to the process. Also there is downward curve of diminished effectiveness as the filter is being used.

In the prior art of venting the odorous air by number of ventilation systems entails various methods and techniques with a common factor of inserting inline electric fan in the methodology. Typically of these are: U.S. Pat. No. 4,989,276 describes the process of modifying the toilet water tank and running an exhaust pipe through the back wall to the top of the building, expelling the obnoxious air into the atmosphere. U.S. Pat. No. 7,103,925 B2 and U.S. Pat. No. 4,094,023 describes a method of drilling a channel into the bowl to the trap to pump the odorous air to the sewer passage out. A rim seat with openings is provided to connect to communicate to the exhaust piping by an in-line fan. to the channel communicating with the sewer. Such arrangements, which directly connect to the sewer trap, may violate plumbing code for leaking sewer gases into the bathroom under abnormal operating conditions. A number of devices have been presented to tackle the problem of odorous air but all of those require electric power for exhaustion. Typical of these are U.S. Pat. No. 4,620,329 and U.S. Pat. No. 4,094,023 modify typical toilet seat, to run channels within to draw the odorous volume by an electric exhaust fan. The odorous volume is finally piped out of the building into the environment. All such methods need and make structural and plumbing changes in and around the toilet bowl and bathroom, adding considerable cost to the project of odor removal.

### SUMMARY OF THE INVENTION

The invention provides a simple system of odor control applicable to existing installations as well as for control of bowl odor with additional benefits; such as wetting the bowl surface. This eases the slide of solids into the captive pool of water thereby reducing the volume of odor coming out of the feces.

Present embodiment of the art of odor control is an insert with fogging nozzles inserted into a semi-circle shape to be installed under the toilet seat using common mounting holes used to install the seat. The fogging nozzles selected are low flow, performing at optimum over a water pressure range of 45-60 psi. This works well with the normal household water supply at 60 psi. Water supply to the insert is arranged by bifurcating the tank water supply piping at the valve. One end of the tubing is connected at the supply point. Other end of the tubing is connected to the control valve on the insert. An in-line filter may be mounted to check flow of solid particles that may end up in nozzle orifices hindering normal nozzle function. Number of nozzles in the insert is based on nozzle flow characteristics and fog volume required to control the odor effectively.

The art is not limited to one embodiment of an insert. A similar arrangement of nozzles may be installed in the toilet seat. Also similar arrangement may be combined with a typical bidet insert by providing separate control valves at the insert for water supply. This description is part of basic design with manual control of water supply during use. However, electronic controls with sensors and electrical power may be substituted for sophisticated installations. Choice of nozzles and material of construction may vary based-on customer demand.

### BRIEF DESCRIPTION OF THE DRAWINGS

FIG. 1 is a diagrammatic perspective view of odor control assembly. Drawing shows an insert 40, sitting over the toilet bowl 13 with odor controlling fogging nozzles and aligned with toilet seat mounting holes 34. The said insert will sit under the toilet seat 30 in the completed assembly. The said insert 40 is connected with household water supply at 50-60 psi by bifurcating water supply to the water tank. The water supply to insert 40 is controlled by valve 22 and connected via hose connection 25-26 with inline filter 23.

FIG. 2 is 3D view of the insert 40 complete with plurality of odor control nozzles 44 fitted underneath and water control valve 43 for water supply to the said fogging nozzles during toilet use. The drawing shows a pair of mounting holes 41 for linear adjustment of the said insert.

FIG. 3 is 3D view of the said insert 40 turned downside up to show details of plurality of fogging nozzles 44 installation and the water inlet 42 for water supply. The drawing also shows a pair of mounting holes 41 for linear adjustment of said insert.

FIG. 4 3D view of another embodiment of the insert 50 which includes Bidet 56 and separate water control valves 53 and 54 for water supply to said plurality of fogging nozzles 55 (not shown) and bidet 56 respectively to supplement and improve the hygiene of the toilet. The drawing also shows a pair of mounting holes 51 slotted for linear adjustment of said insert.

FIG. 5 is 3D view of the said insert 50 turned downside up to show detail of installed components, said plurality of fogging nozzles 55, said bidet 56, and water supply inlet 52. This drawing also shows a pair of said mounting holes 51 slotted for linear adjustment of said insert.

FIG. 6 is non-conventional view of the said insert 40 showing internal details of water supply tubing 45 for supply of water to the said fogging nozzles 44 during use of the toilet. Drawing shows water supply to the said fogging nozzles 44 through water supply control valve 43 and water inlet 42. The drawing also shows a pair of mounting holes 41 slotted for linear adjustment of said insert 40.

FIG. 7 is a vertical sectional cut to further clarify said plurality of fogging nozzles 44 installation, water supply control valve 43 and water supply tubing 45. The drawing also shows a pair of mounting holes 41 slotted for linear adjustment of said insert 40.

FIG. 8 is a non-conventional view of the insert 50 to show internal details of a plurality of fogging nozzles 55 and bidet 56. The drawing shows water supply tubing 57 to the plurality of fogging nozzles 55 and water supply tubing 58 to said bidet 56. The drawing shows water supply control valves 53 and 54 supplying water to plurality of said fogging nozzles 55 and said bidet 56.

FIG. 9 is a vertical sectional cut to further clarify said plurality of fogging nozzles 55 and said bidet installation 56 showing two separate control valves 53 and 54 for independent water supply tubing 57 and 58 to a plurality of fogging nozzles 55 and said bidet 56 from the said water control valves 53 and 54.

### SPECIFICATIONS

### 1. Title: Toilet Bowl Odor Control by Fogging Nozzles

2. The device is a retrofit insert with plurality of fogging nozzles. The said insert is installed under the toilet seat on two common mounting holes. The said fogging nozzles are connected to household water supply at 40-60 psi and are designed to use minimal water in the process. The said nozzles are directed to fog the interior of the toilet bowl when the toilet is being used.

### 3. Process

During use of the toilet, the fog particles enclose the odor molecules and proceed to form water drops by the inherent property of surface tension. Water drops, thus formed with enclosed odor molecules drop into the bowl water pool and are finally flushed down the drain.

### 4. Preferred Benefit of the Process

Unlike many odor control devices where odor particles are evacuated and are discharged thereby degrading the environment—the present invention described here captures and disposes of the offensive odors into the sanitary sewer system. Also the toilet bowl interior surface is coated with a thin film of water droplets which promotes hygiene and cleanliness and saves water by requiring fewer flushes to effectively cleanse the bowl.

### 5. Various Embodiments

Presently submitted information encompasses use of fogging nozzles to control toilet bowl odor and within that includes bidet in another embodiment of the invention described in this patent application. The scope of this invention also includes use of electrical power and other devices when deemed necessary to improve performance of different embodiments of this invention.

### DETAILED DESCRIPTION OF THE EMBODIMENT

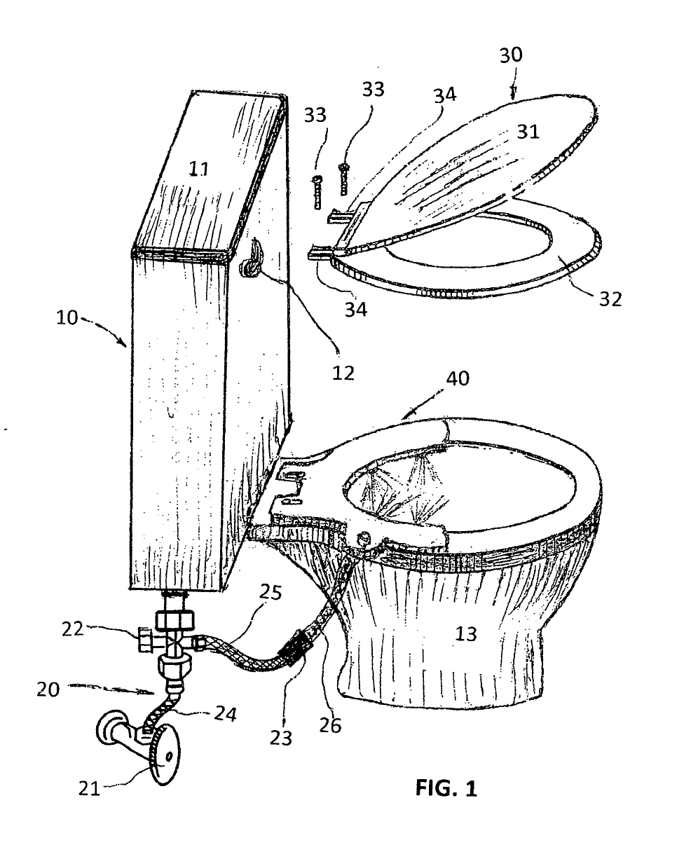

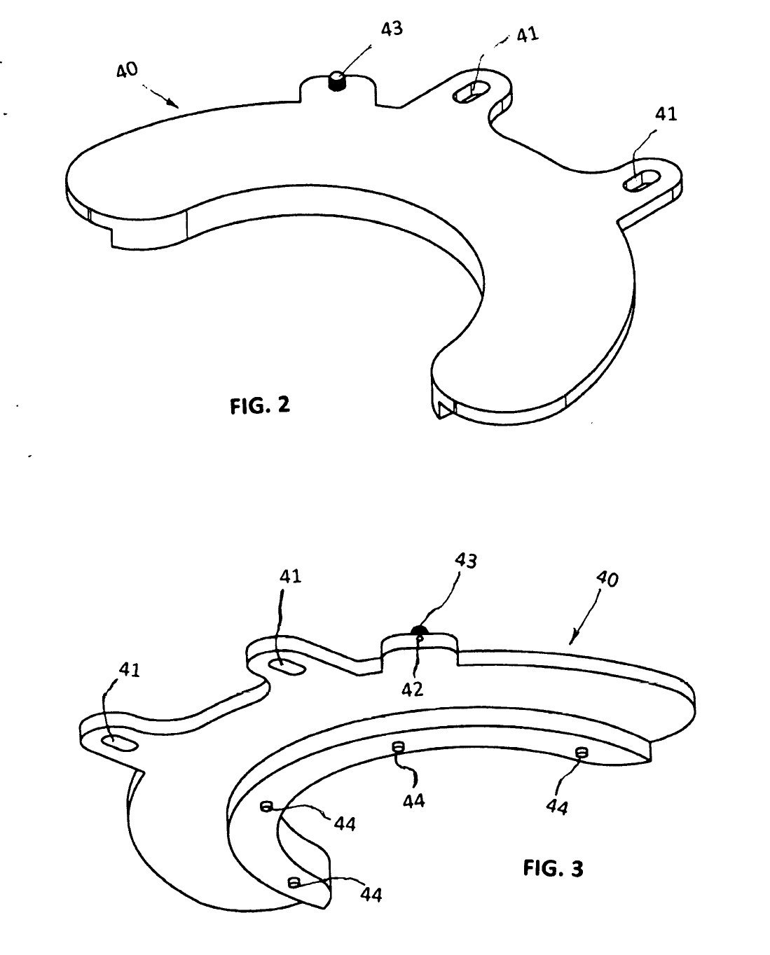

Referring to FIG. 1 assembly drawn to show location of an insert 40 over top of the toilet bowl rim mounted under toilet seat 30 with two aligned mounting holes 34 on the seat extensions. The insert is mounted with plurality of fogging nozzles to control obnoxious and unhealthy odor during usage of the toilet. Details of insert 40 are given on FIGS. 2 and 3.

The assembly consists of the Toilet water supply storage tank 10; accompanying toilet bowl 13 and a flushing lever 12. The household water supply line 20 at 40 to 60 psi is bifurcated to supply water to the fogging nozzles; a water supply control valve 22 to the fogging nozzles is installed to control water supply. This valve is kept open for continuous availability of water supply to the nozzles through said control valve 43 shown in FIG. 2. An in-line water filter 23 of suitable filtration capacity is installed between tubing 25 and 26 to remove oversize solid particles from the household water supply to avoid clogging of nozzle orifices. Tubing 26 connects in-line filter to water inlet 42 to control valve 43 on the said insert 40.

The toilet seat 30 FIG. 1 consists of two parts; one oval under part 32 with oval opening aligned with toilet oval rim surface and the other part 31 solid cover on the toilet bowl when not in use. Back of the toilet seat has two extensions with slotted mounting holes 34. Toilet seat is furnished with two long carriage bolts to attach to the top of the toilet bowl rim.

The heart of the invention is the fabricated insert 40 configured to sit on the toilet bowl rim and easily mounted under the toilet seat with common mounting holes and hardware. The said insert is mounted with a plurality of fogging nozzles directed towards the interior of the toilet bowl. Water supply to the fogging nozzles is controlled by a valve 43 FIG. 2 mounted on the side of the insert and connected to receive water supply from control valve 22 FIG. 1 of water supply line to the toilet said water supply storage tank.

FIG. 2 is 3D view of the said insert 40 showing top surface of the said insert. It identifies water supply control valve to the said fogging nozzles and slotted mounting holes 41 aligned with toilet seat mounting.

FIG. 3 shows under side of the said insert turned downside up showing details of the plurality of nozzles 44 mounting under the insert. It also shows entry point of water inlet tubing connected to the water control valve supplying water to the said nozzles during usage of the toilet. Material of construction of the insert and other components may be constructed from various materials of construction for such components and are mostly of suitable plastics for economy without sacrificing performance.

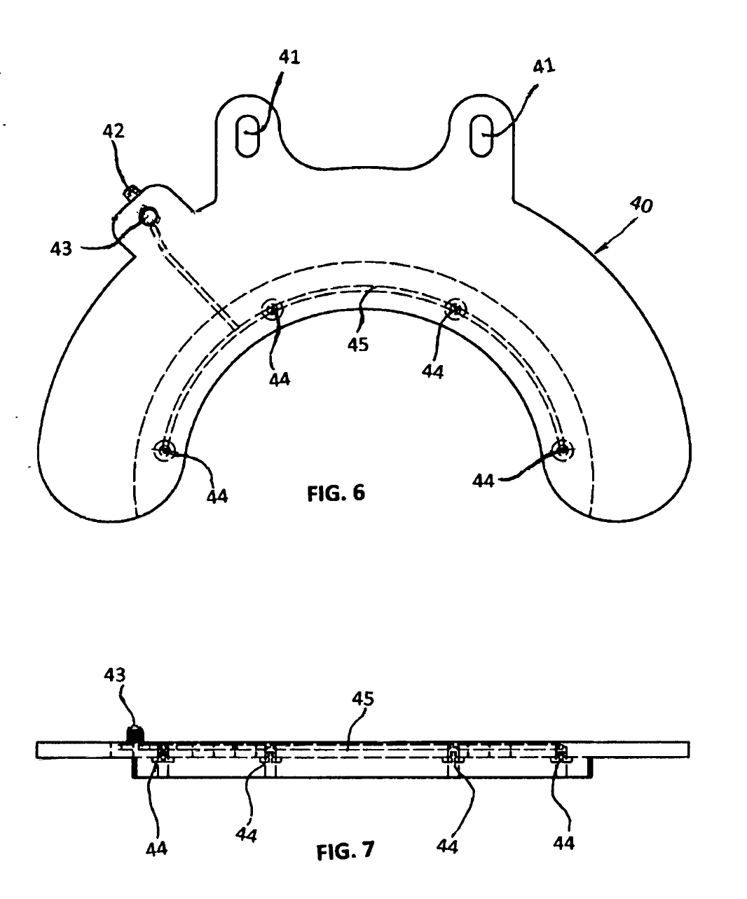

FIG. 6 is an orthographic top view showing interior details of tubing 45 connecting and supplying water to the said nozzles 44 during usage of the toilet. FIG. 7 is vertical running section to show further detail of the insert cutout view.

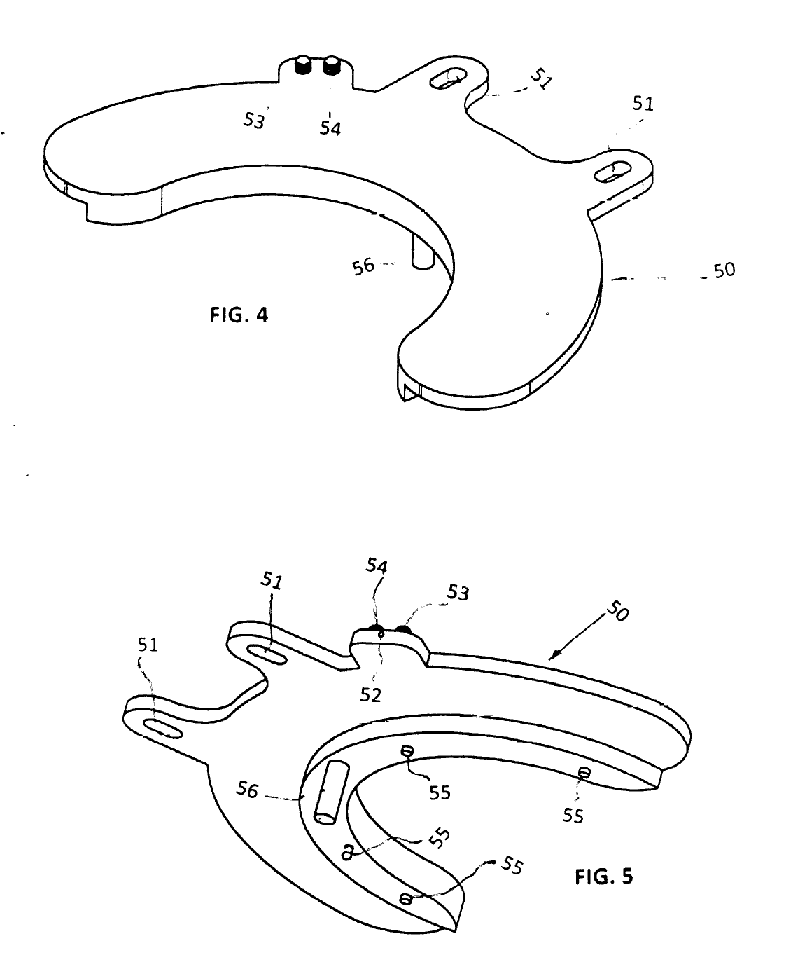

Another embodiment shown in FIG. 4 and FIG. 5 of odor control system from the toilet bowl is envisaged in this invention by providing a bidet 56 along with fogging nozzles in the insert 50 to promote healthy environment in the toilet usage.

FIG. 4 shows 3D view of the another said embodiment of the insert by adding bidet nozzle 56 receiving water supply from water supply control valve 54. Water supply to the fogging nozzles and bidet in fed from the same inlet 52 to both of the water supply control valves. The said insert 50 is furnished with slotted mounting holes to mount the said insert under the toilet seat 30 FIG. 1 with common hardware.

FIG. 5 is a 3D view of the same embodiment of the said insert 50 turned downside up to show mounting detail of fogging nozzles 55 and bidet 56. It also shows common water supply inlet 52 to the two water control valves supplying water to fogging nozzles and bidet independent of each system.

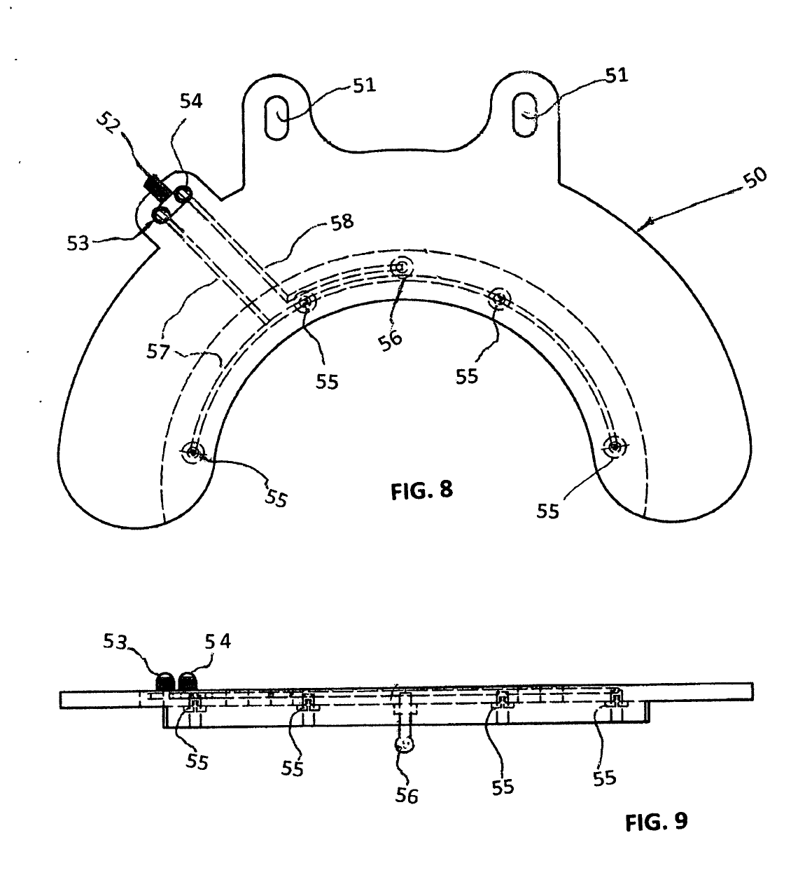

FIG. 8 is orthographic top view of the insert with bidet. It shows single water inlet 52 to supply water to fogging nozzles 55 from water control valve 53 through tubing 57 and water supply to bidet 56 through said control valve 54 into tubing 58 connected to the said bidet.

FIG. 9 is shown a vertical running section to clarify further detail of the invention embodiment; improving and promoting overall healthy environment in the toilet section of bathrooms.

During usage of the toilet, water supply to the fogging nozzles is switched on by the said water supply control valve filling the bowl interior with fog. Fog particles immediately start to enclose the odor molecules and turn into water drops and drop into the water pool at the bottom of the bowl. Eventually the captured odor is flushed into the drain along with the rest of excreted stuff.

The other embodiment whereby odor control system added to the existing bidet with slightly larger insert improves overall hygienic environment of the toilet space.

The odor control system together with embodiments as delineated in the drawings from FIG. 1 thru FIG. 9 can be retrofitted on any standard toilet bowl without making expensive structural changes around toilet areas. The bidet insert as is currently in use in bathrooms is a popular retrofit on the toilets to improving bathroom hygiene. Adding fogging nozzles as shown in FIGS. 4 and 5 delivers ideal solution to the poor hygiene in the present standard toilet installations.

What is claimed is:

1. A device for toilet bowl odor control system during usage of the toilet comprising of: an insert under the toilet seat with plurality of fogging nozzles mounted therein;
number and placement of Fogging nozzles in the insert based on fogging characteristics covering effected volume of the said toilet bowl, an assembly of parts to meet service requirements of odor control from the said toilet bowl;
Fogging nozzles are characterized by producing fog of less than 75 microns;
Fogging of the nozzles flow directed to the interior volume of the bowl;
the said insert shaped for mounting location and hardware common with toilet seat;
water supply to the fogging nozzles from household water pressure of 40-60 psi;
a 3 way bifurcating valve supplying to the toilet tank and the other to the flow control box attached to the said insert;
a valve installed in the said flow control box attached to the said insert controlling water supply to the said fogging nozzles when the toilet is in use;
Tubing from bifurcating device to control box of approved plumbing flexible plastic tubing of adequate strength to withstand household water pressure and temperature;
An in-line filter of suitable mesh characteristics installed for removing oversize solid particulate in the water supply line to the said fogging nozzles during toilet use;
Tubing connection made by flaring both ends or other mechanical methods to obtain leak-proof connections.

2. The toilet bowl odor control system of claim 1 is further characterized by removing toilet odors during use by the atomizing fog enclosing and absorbing odor molecules which fall into standing bowl water.

3. The toilet bowl odor control system of claim 1 is further characterized that the bifurcating valve simultaneously supplying uninterrupted water to the toilet tank and the said flow control valve attached to the said insert.

4. The toilet bowl odor control system of claim 1 is further characterized by that it precludes any structural changes to the building for installation of odor control from the toilet bowl.

5. The toilet bowl odor control system of claim 2 is further characterized by absorbing the odor molecules by the fogging mist and dumping the mixture into standing water of the said toilet bowl.

6. The toilet bowl odor control system is characterized by maintaining cleaner environment in the bathroom and outside of the building.

7. The toilet bowl odor control system of claim 1 is further characterized that the insert and the fogging nozzles are fabricated from suitable plastics or steel for durable service.

8. A method of using the odor control system comprising the following steps:
plurality of atomized fog particles produced by the fogging nozzles in the interior of the toilet bowl encloses the odor molecules;
odor particles are further engulfed by the inherent property of surface tension of atomized fog to form water droplets;
finally fog particles in the process of forming water drops absorb the odor molecules;
water drops carrying odor molecules fall into the bowl to be flushed out with rest of the excretions;
a. Ensure that the valve at the water control box attached to the insert is in “ON” position either manually or electric switching prior to use of the toilet by the user;
b. ensure that the fogging nozzles are fully operative and the interior surface of the toilet bowl is wetted before use;
c. flush the toilet bowl manually or as arranged by electric circuit;
d. shut off the said valve supplying water to the fogging nozzles manually or by electric circuit;
e. use cleaner and or brush for final rinse of the said toilet bowl.
